(19) United States
(12) Patent Application Publication
(10) Pub. No.: US 2026/0125027 A1
(43) Pub. Date: May 7, 2026

(54) METHODS AND SYSTEMS FOR GESTURE-BASED CONTROLS OF VEHICLES

(71) Applicant: Toyota Jidosha Kabushiki Kaisha, Toyota-shi (JP)

(72) Inventors: Alexander Charles Granieri, Palo Alto, CA (US); Tristan R. Littlehale, Saratoga, CA (US); Conor Sullivan, Campbell, CA (US); Jimmy Chiu, San Jose, CA (US)

(73) Assignee: Toyota Jidosha Kabushiki Kaisha, Toyota-shi (JP)

(21) Appl. No.: 18/939,016

(22) Filed: Nov. 6, 2024

(51) Int. Cl. B60R 25/24; B60R 25/25; B60R 25/30; G06F 21/32; G07C 9/00

(52) U.S. Cl. CPC B60R 25/241; B60R 25/25; B60R 25/305; G06F 21/32; G07C 9/00309; G07C 9/00563; G06F 2221/2141; G06F 2221/2145; G07C 2009/00793; G07C 2009/00984; G07C 2209/63

(57) ABSTRACT

Systems for granting access to a vehicle control system may include a vehicle, a camera mounted to the vehicle, one or more processors of an electronic control unit, at least one memory module communicatively coupled to the one or more processors, and machine readable instructions stored in the at least one memory module. The machine readable instructions stored in the at least one memory module may cause the one or more processors to identify a user based on photos or videos obtained from the camera and may classify the user as: (i) a privileged user, (ii) an inherited privilege user, or (iii) a non-privileged user based on photos or videos obtained from the camera. The privileged user, inherited privilege user, and non-privileged user may be granted varying levels of access to gesture-based controls of the vehicle.

### TECHNICAL FIELD

The present disclosure relates to a vehicle control system and, more particularly, to computer-assisted processing technologies for controlling vehicles.

### BACKGROUND

Traditional vehicle control systems generally include steering controls, infotainment controls, climate controls, etc. Other vehicle control systems may include gesture-based controls where a user controls the vehicle based on gestures made by the user from images and videos on a vehicle camera. Moreover, a user generally gains access to the interior of the vehicle and, thus, access to the traditional vehicle control systems, through the use of a key fob. In the case of gesture-based controls, the user controls the vehicle while external to the vehicle interior. However, the traditional vehicle control systems do not have a way of authenticating particular users giving gesture-based controls. Such lack of authentication is problematic, as it is not desired that the vehicle accepts control commands from all users, only those who the owner desires to have access to the vehicle control systems. Therefore, a need exists for classifying users giving gesture-based controls to a vehicle, and granting varying levels of access to the gesture-based controls based on the user classification.

### SUMMARY

In an aspect of the present disclosure, a vehicle control system includes a vehicle, a camera mounted to the vehicle, one or more processors of an electronic control unit, at least one memory module communicatively coupled to the one or more processors, and machine readable instructions stored in the at least one memory module. The machine readable instructions stored in the at least one memory module cause the one or more processors to identify a user based on photos or videos obtained from the camera and classify the user as: (i) a privileged user, (ii) an inherited privilege user, or (iii) a non-privileged user based on photos or videos obtained from the camera. The privileged user, inherited privilege user, and non-privileged user are granted varying levels of access to gesture-based controls of the vehicle.

In another aspect of the present disclosure, a vehicle control system includes a vehicle, a camera mounted to the vehicle, one or more processors of an electronic control unit, at least one memory module communicatively coupled to the one or more processors, and machine readable instructions stored in the at least one memory module. The machine readable instructions stored in the at least one memory module cause the one or more processors to identify a user based on photos or videos obtained from the camera and classify the user based on key fob proximity as: (i) a privileged user, (ii) an inherited privilege user, or (iii) a non-privileged user based on photos or videos obtained from the camera. The privileged user, inherited privilege user, and non-privileged user are granted varying levels of access to gesture-based controls of the vehicle. The gesture-based controls of the vehicle allow the user to move the vehicle, unlock the vehicle, capture an image or video with the camera, activate lights of the vehicle, or start the vehicle.

In yet another aspect of the present disclosure, a method of granting access to a vehicle control system includes identifying a user based on photos or videos obtained from a camera mounted on a vehicle, classifying the user as: (i) a privileged user, (ii) an inherited privilege user, or (iii) a non-privileged user based on photos or videos obtained from the camera, and granting varying levels of access to gesture-based controls of the vehicle based on whether the user is classified as the privileged user, inherited privilege user, or non-privileged user.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an illustrative system for granting access to a vehicle control system, according to one or more embodiments shown and described herein;

FIG. 2 schematically depicts non-limiting components of the devices of the system for granting access to a vehicle control system, according to one or more embodiments shown and described herein; and

FIG. 3 schematically depicts a flow chart of an illustrative method for granting access to a vehicle control system, according to one or more embodiments shown and described herein.

### DETAILED DESCRIPTION

The embodiments described herein are directed to methods and systems controlling a vehicle, specifically, through gesture-based commands based on photos or videos obtained by a camera. The systems, methods, and computer implemented programs may utilize various algorithms and artificial intelligence for controlling the vehicle.

Gesture-based control systems of vehicles may include cameras mounted on the exterior of a vehicle to identify gestures through photos or videos made by users to control the vehicle based on such gestures. However, it is undesirable for all users to be able to utilize the gesture-based controls of the vehicle, as an owner of the vehicle may only want himself or other authorized users to be able to have access to the gesture-based controls. Thus, gesture-based control systems of a vehicle presents difficulties in determining which users should have access to the gesture-based controls of the vehicle.

The vehicle control system of the present disclosure includes identifying a user based on photos or videos obtained from a camera mounted on the vehicle. The user is classified as (i) a privileged user, (ii) an inherited privilege user, or (iii) a non-privileged user based on photos or videos obtained from the camera. The privileged user, inherited privilege user, and non-privileged user are granted varying levels of access to the gesture-based controls of the vehicle using the systems and methods described herein.

As used herein, the singular forms “a,” “an” and “the” include plural referents unless the context clearly dictates otherwise. Thus, for example, reference to “a” component includes aspects having two or more such components unless the context clearly indicates otherwise.

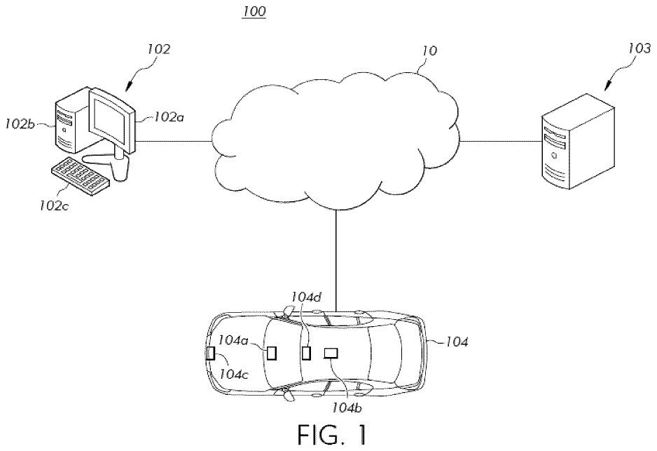

Referring to FIG. 1, an illustrative embodiment of a vehicle control system 100 is depicted. The system 100 depicted in FIG. 1 includes a computing device 102, a server 103, and a vehicle 104 connected to each other via a network 10. As illustrated in FIG. 1, the network 10 may include a wide area network, such as the internet, a local area network (LAN), a mobile communications network, a public service telephone network (PSTN) and/or other network and may be configured to electronically connect a computing device 102, a server 103, and/or a vehicle 104.

The computing device 102 may include a graphical user interface (GUI) 102a, one or more processors 102b and an input device 102c, each of which may be communicatively coupled to together and/or to the network 10. The server 103 may be configured to include similar components as the computing device 102. As described in more detail herein, the computing device 102 may be configured to receive a data set (e.g., photo or video data) from the camera 104c and identify a user based on the received data set. Moreover, the user may input photos or videos of authorized users by utilizing the input device 102c of the computing device 102. The server 103 may also be configured to perform operations described herein with reference to the computing device 102. It is noted that although the computing device 102 is depicted as being external to the vehicle 104 and communicatively coupled to the vehicle via the network 10, it should be understood that the computing device 102 may be integrated into the vehicle 104, such that the computing device 102 may be a head unit of the vehicle 104.

It should be understood that the computing device 102, the server 103, and the electronic control unit 104a of the vehicle 104 may be a personal computer, a micro controller, mobile device, head unit, or the like. Additionally, while each of the computing devices illustrated in FIG. 1 are depicted as single pieces of hardware, this is also an example. More specifically, each of the computing device 102, the server 103, and electronic control unit 104a may represent a plurality of computers, servers, databases, and the like. As such, the computing device 102 and/or the server 103 may receive photos or videos from the vehicle 104, and store the photos or videos on a memory module 260 (discussed further herein below).

The vehicle 104 includes an electronic control unit 104a, a communications unit 104b, a camera 104c, and sensors 104d. The electronic control unit 104a may be any device or combination of components comprising a processor and non-transitory computer readable memory. The processor may be any device capable of executing the machine-readable instruction set stored in the non-transitory computer readable memory. Accordingly, the processor may be an electric controller, an integrated circuit, a microchip, a computer, or any other computing device. The processor is communicatively coupled to the other components of the vehicle 104 by a communication bus. Accordingly, the communication bus may communicatively couple any number of processors with one another, and allow the components coupled to the communication bus to operate in a distributed computing environment. Specifically, each of the components may operate as a node that may send and/or receive data. It is further noted that the processor may comprise a single processor, multiple processors, or a system of processors.

The communications unit 104b of the vehicle 104 may include network interfaces for one or more of a plurality of different networks, protocols, or the like. For instance, the communications unit 104b may include one or more antennas (e.g., many in/many out (MIMO) antennas, etc.) that may allow for communication via Wi-Fi networks, IrDA, Bluetooth, Wireless USB, Z-Wave, ZigBee, near field communication (NFC), LTE, WiMAX, UMTS, CDMA, C-V2X, GSM interfaces may include Wi-Fi, xth generation cellular technology (e.g., 2G, 3G, 4G, 5G, etc.), WCDMA, LTE Advanced, or the like.

The electronic control unit 104a is configured to be communicatively coupled to one or more cameras 104c. In embodiments, the one or more cameras 104c may be any camera capable of capturing photos or videos. In embodiments, the electronic control unit 104a may also be communicatively coupled to one or more sensors 104d. The one or more sensors 104d may be any sensors that are capable of user recognition, such as infrared sensors, radio wave sensors, biometric sensors (e.g., fingerprint scanners), or any other suitable sensor. In embodiments, the one or more sensors 104d may also include a microphone for capturing audio. The electronic control unit 104a and communications unit 104b may communicate the data generated by the camera 104c or sensors 104d to the computing device 102 and/or the server 103 through the network 10, or any other suitable communication path.

A data storage component 268 and/or the memory module 260 of the computing device 102 or a memory of the server 103 may store the data from the cameras 104c or the sensors 104d of the vehicle 104. In some embodiments, the computer and the server 103 may be communicatively connected to a plurality of vehicles 104, such that the memory of the computing device 102 and server 103 include data from each of the plurality of vehicles 104. The computing device 102 and server 103 may aggregate the data from the plurality of vehicles 104, such that the aggregated data may be used to classify users, as described further herein.

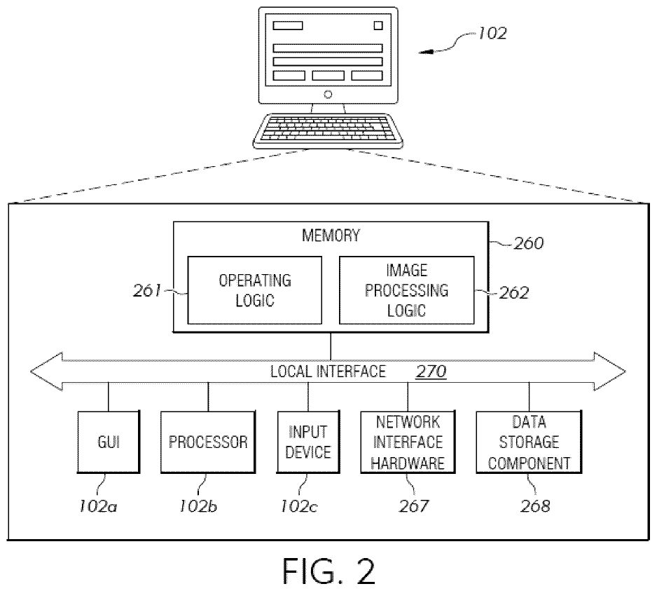

Referring now to FIG. 2, non-limiting components of the computing device 102 are depicted. While in some embodiments, the computing device 102 may be configured as a general purpose computer with the requisite hardware, software, and/or firmware, in some embodiments, the computing device 102 may be configured as a special purpose computer designed specifically for performing the functionality described herein. It should be understood that the software, hardware, and/or firmware components depicted in FIG. 2 may also be provided in other computing devices external to the computing device 102 (e.g., the server 103, data storage devices, remote server computing devices, and the like).

As depicted in FIG. 2, the computing device 102 (or other additional computing devices) may include various components, such as but not limited to the processor 102b, the graphical user interface 102a, the input device 102c, a network interface hardware 267, a data storage component 268 (which may include photos, videos, or other data for performing the functionalities described herein), and a non-transitory memory module 260. The memory module 260 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components.

Additionally, the memory module 260 may be configured to store logic, such as but not limited to operating logic 261 and image processing logic 262 for receiving and processing images and videos from the camera 104c of the vehicle 104, as described herein (each of which may be embodied as computer readable program code, firmware, or hardware, as an example). It should be understood that the data storage component 268 may reside local to and/or remote from the computing device 102, and may be configured to store one or more pieces of data for access by computing device 102 and/or other components.

A local interface 270 is also included in FIG. 2 and may be implemented as a bus or other interface to facilitate communication among the components of the computing device 102.

The processor 102b may include any processing component configured to receive and execute computer readable code instructions (such as from the data storage component 268 and/or memory module 260). The input device 102c may include one or more of graphics display device, keyboard, mouse, printer, camera, microphone, speaker, touch-screen, and/or other device for receiving, sending, and/or presenting data. The network interface hardware 267 may include any wired or wireless networking hardware, such as a modem, LAN port, wireless fidelity (Wi-Fi) card, WiMax card, mobile communications hardware, and/or other hardware for communicating with other networks and/or devices. The network interface hardware 267 may communicate via the Internet to receive photo, video, or other data provided from one or more sources (e.g., one or more cameras 104c or one or more sensors 104d of the vehicle 104) as well as communicate with a display device, such as the GUI 102a of the computing device 102 to display photos, videos, or other data.

Included in the memory module 260 may be the operating logic 261 and image processing logic 262. The operating logic 261 may include an operating system and/or other software for managing components of the computing device 102. Similarly, the image processing logic 262 may reside in the memory module 260 and may be configured to receive and process image data, such as to identify and classify users, as discussed further below. The logic or algorithm(s) may be written in any programming language of any generation (e.g., 1GL, 2GL, 3GL, 4GL, or 5GL) such as, for example, machine language that may be directly executed by the processor 102b, or assembly language, object-oriented programming (OOP), scripting languages, microcode, etc., that may be compiled or assembled into machine readable instructions (e.g., logic) and stored in the memory module 260. It is noted that the aforementioned logics are referred to herein generally as “the logic,” which may refer to each of the logics recited above.

In embodiments, the logic set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. For example, the memory module 260 may be a machine-readable memory (which may also be referred to as a non-transitory processor-readable memory or medium) that stores instructions that, when executed by the processor 102b, causes the processor 102b to perform user classification, as described herein.

The components illustrated in FIG. 2 are merely exemplary and are not intended to limit the scope of this disclosure. More specifically, while the components in FIG. 2 are illustrated as residing within the computing device 102 this is a non-limiting example. In some embodiments, one or more of the components may reside external to the computing device 102.

The logic stored on the memory module 260, when executed by the processor 102b, may cause the system 100 to receive a data set (such as images, videos, or other data from the camera 104c or sensors 104d of the vehicle 104, described hereinabove). The logic may also cause the system 100 to identify a user, classify the user as: (i) a privileged user, (ii) an inherited privilege user, or (iii) a non-privileged user based on photos or videos obtained from the camera 104c, and grant varying levels of access to gesture-based controls of the vehicle 104 based on whether the user is classified as the privileged user, inherited privilege user, or non-privileged user, as described further below.

As noted hereinabove, the system 100 may identify the user based on photos or videos obtained from the camera 104c and classify the user as (i) a privileged user, (ii) an inherited privilege user, or (iii) a non-privileged user based on photos or videos obtained from the camera 104c. The system 100 may then grant varying levels of access to gesture-based controls of the vehicle 104 based on the user classification.

The gesture-based controls of the vehicle 104 may allow the user to control the vehicle 104 in a variety of manners. In embodiments, the gesture-based controls of the vehicle 104 may allow the user to move the vehicle 104, unlock the vehicle 104, capture an image or video with the camera 104c, activate lights of the vehicle 104, or start the vehicle 104. As noted herein, the privileged user, inherited privilege user, and non-privileged user may be granted varying levels of access to the aforementioned gesture-based controls of the vehicle 104.

The gesture-based controls of the vehicle 104 may be activated when the system 100 recognizes that the privileged user or inherited privilege user performs a gesture that is stored on the memory module 260. Such gestures may include waving, jumping, hand gestures (such as thumbs up, pointing a certain direction, or mimicking a photo-capturing gesture), or any other recognizable gestures. In embodiments, the user may customize the system 100, such that the vehicle performs a function based on any corresponding gesture of the user captured by the camera 104c and recognized by the system 100. The user may also customize what gesture-based commands are accessible to the inherited privilege user, as described further below.

In embodiments, the privileged user may have access to more gesture-based controls of the vehicle 104 compared to that of the inherited privilege user, and the inherited privilege user may have access to more gesture-based controls of the vehicle 104 compared to that of the non-privileged user.

In embodiments, the privileged user may have unlimited access to the gesture-based controls of the vehicle 104. As such, the privileged user may have access to any of the gesture-based controls of the vehicle 104. In contrast, the inherited privilege user may have limited access to the gesture-based controls of the vehicle 104. In embodiments, the inherited privilege user may only have access to the photo/video-taking capabilities of the gesture-based controls of the vehicle 104. The non-privileged user may have limited or no access to the gesture-based controls of the vehicle 104. In embodiments, the non-privileged user may only have access to the gesture-based controls of the vehicle 104 in emergency situations, such as when the system 100 recognizes that the non-privileged user is attempting to contact emergency services, such as through the audio information obtained from the microphone of the vehicle 104. Such emergency situation may be determined by the system 100 when a user says “call 911” or “call emergency services” and the system 100 recognizes such audio through the microphone. The system 100 may contact emergency services, note a location of the vehicle 104, and provide emergency services with the audio recorded by the microphone.

The privileged user, inherited privilege user, and non-privileged user may be classified in a variety of manners. For example, the privileged user may be an owner of the vehicle 104. The privileged user may upload facial recognition data onto the memory module 260. Thus, the system 100 may recognize the privileged user through the image processing logic 262 through facial recognition. In embodiments, the privileged user may also be users that the owner has decided to grant full access to the gesture-based controls of the vehicle 104. For example, the privileged user may also grant full access to the gesture-based controls of the vehicle 104 to a family member, friend, or caretaker. The privileged user may also classify some users as inherited privilege users that have limited access to the gesture-based controls of the vehicle 104 even when the inherited privilege user is not within a threshold proximity of the privileged user, as described further below.

In embodiments, the system 100 may classify the inherited privilege user based on a threshold proximity from the privileged user. For example, if the privileged user is standing in front of the vehicle 104 near another user to take a photograph, users within a threshold proximity from the privileged user may be classified as inherited privilege users. As such, the inherited privilege users may be granted access to the gesture-based controls of the vehicle 104 that allow the inherited privilege user to capture images/videos with the camera 104c. Moreover, users outside of the threshold proximity from the privileged user may be classified as non-privileged users that have no access to the gesture-based controls of the vehicle 104. As such, non-privileged users may be those standing in the background of a photo/video that the privileged user is attempting to capture through the camera 104c.

The system 100 may also classify users based on key fob proximity. For example, the system 100 may recognize a location of the key fob based on the sensors 104d on the vehicle 104 (such as through radio wave sensors). In such embodiments, the system 100 may classify the privileged user as a user standing nearest the key fob or holding the key fob. Moreover, inherited privilege users may be classified as standing within a threshold proximity of the key fob. In embodiments, the threshold proximity from the privileged user (either in the case of distance from the privileged user as recognized by the camera 104c through facial recognition or distance from the privileged user as defined by the key fob proximity) may be 1 foot, 2 feet, 3 feet, 5 feet, 10 feet, or any other suitable threshold distance.

In embodiments, the owner of the vehicle 104 may input user identities into a user database stored on the memory module 260. As such, the owner of the vehicle 104 may upload his or her own facial image and instruct the system 100 that they are the owner and should be classified as the privileged user. The owner may also upload other facial images of people whom the owner would like the system 100 to classify as privileged users (such as family members or friends). The owner may further upload facial images of people whom the owner would like the system 100 to classify as inherited privilege users. As such, there may be a plurality of privileged users or non-privileged users that the system 100 recognizes through facial identification.

In embodiments, the vehicle 104 may be communicatively coupled to a network of vehicles. As such, the owner of the vehicle 104 may choose to allow privileged users of other vehicles in the network to be privileged users of the owner's vehicle 104. For example, the owner of the vehicle 104 may have four vehicles within the owner's family. All four vehicles may be communicatively coupled to one another to form a network of vehicles, such that each of the privileged users for each vehicle is also labeled as a privileged user for all other vehicles that are communicatively coupled to one another in the network of vehicles.

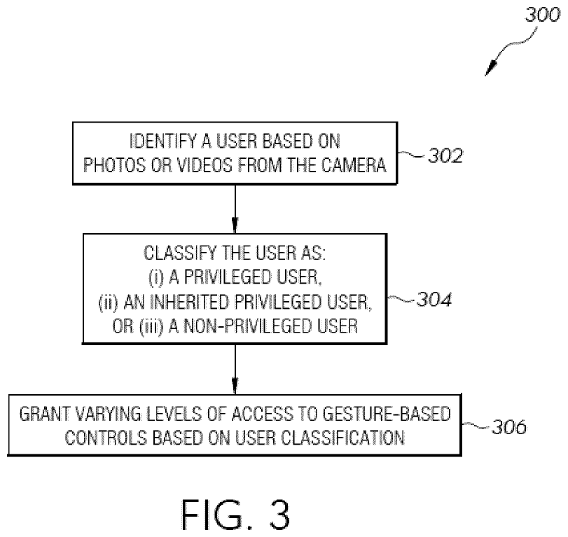

Referring now to FIG. 3, a flow diagram of a method 300 of granting access to a vehicle control system 100 is depicted. At block 302, a user is identified based on photos or videos obtained from the camera 104c mounted on the vehicle 104. At block 304, the user is classified as (i) a privileged user, (ii) an inherited privilege user, or (iii) a non-privileged user based on photos or videos obtained from the camera 104c of the vehicle 104. At block 306, varying levels of access are granted to gesture-based controls of the vehicle based on whether the user is classified as the privileged user, inherited privilege user, or non-privileged user.

The method 300 may further include classifying the user based on key fob proximity or classifying the user based on facial recognition. The facial recognition may be based on photos or videos captured from the camera 104c, or image data obtained from the sensors 104d. The method 300 may further include classifying the inherited privilege user based on a threshold proximity from the privileged user.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle control system comprising:
a vehicle;
a camera mounted to the vehicle;
one or more processors of an electronic control unit;
at least one memory module communicatively coupled to the one or more processors; and
machine readable instructions stored in the at least one memory module, wherein:
the machine readable instructions stored in the at least one memory module cause the one or more processors to perform at least the following:
identify a user based on photos or videos obtained from the camera; and
classify the user as: (i) a privileged user, (ii) an inherited privilege user, or (iii) a non-privileged user based on photos or videos obtained from the camera, wherein:
the privileged user, inherited privilege user, and non-privileged user are granted varying levels of access to gesture-based controls of the vehicle.

2. The vehicle control system of claim 1, wherein the gesture-based controls of the vehicle allow the user to:
move the vehicle;
unlock the vehicle;
capture an image or video with the camera;
activate lights of the vehicle; or
start the vehicle.

3. The vehicle control system of claim 1, wherein the machine readable instructions cause the one or more processors to perform the following:
classify the user based on key fob proximity.

4. The vehicle control system of claim 3, wherein:
the privileged user is a user holding the key fob;
the inherited privilege user is a user within a threshold proximity of the privileged user holding the key fob; and
the non-privileged user is a user outside of the threshold proximity of the privileged user holding the key fob.

5. The vehicle control system of claim 1, wherein the machine readable instructions cause the one or more processors to perform the following:
classify the user based on facial recognition based on photos or videos captured from the camera.

6. The vehicle control system of claim 5, wherein the inherited privilege user is classified based on a threshold proximity from the privileged user.

7. The vehicle control system of claim 1, wherein the privileged user has access to more gesture-based controls of the vehicle compared to that of the inherited privilege user and the inherited privilege user has access to more gesture-based controls of the vehicle compared to that of the non-privileged user.

8. The vehicle control system of claim 7, wherein the inherited privilege user has access to gesture-based controls of the vehicle for capturing a photo.

9. The vehicle control system of claim 1, wherein the at least one memory module comprises a user database comprising user identities, wherein the machine readable instructions cause the one or more processors to perform the following:
classify the user as the privileged user, the inherited privilege user, or the non-privileged user by matching the user with one of the user identities of the user database through facial recognition based on photos or videos captured from the camera.

10. A vehicle control system comprising:
a vehicle;
a camera mounted to the vehicle;
one or more processors of an electronic control unit;
at least one memory module communicatively coupled to the one or more processors; and
machine readable instructions stored in the at least one memory module, wherein:
the machine readable instructions stored in the at least one memory module cause the one or more processors to perform at least the following:
identify a user based on photos or videos obtained from the camera; and
classify the user based on key fob proximity as: (i) a privileged user, (ii) an inherited privilege user, or (iii) a non-privileged user based on photos or videos obtained from the camera, wherein:
the privileged user, inherited privilege user, and non-privileged user are granted varying levels of access to gesture-based controls of the vehicle, wherein the gesture-based controls of the vehicle allow the user to:
move the vehicle;
unlock the vehicle;
capture an image or video with the camera;
activate lights of the vehicle; or
start the vehicle.

11. The vehicle control system of claim 10, wherein:
the privileged user is a user holding the key fob;
the inherited privilege user is a user within a threshold proximity of the privileged user holding the key fob; and
the non-privileged user is a user outside of the threshold proximity of the privileged user holding the key fob.

12. The vehicle control system of claim 10, wherein the privileged user has access to more gesture-based controls of the vehicle compared to that of the inherited privilege user and the inherited privilege user has access to more gesture-based controls of the vehicle compared to that of the non-privileged user.

13. The vehicle control system of claim 12, wherein the inherited privilege user has access to gesture-based controls of the vehicle to capture a photo.

14. The vehicle control system of claim 10, wherein one or more users are privileged users.

15. A method of granting access to a vehicle control system, the method comprising:
identifying a user based on photos or videos obtained from a camera mounted on a vehicle;
classifying the user as: (i) a privileged user, (ii) an inherited privilege user, or (iii) a non-privileged user based on photos or videos obtained from the camera; and
granting varying levels of access to gesture-based controls of the vehicle based on whether the user is classified as the privileged user, inherited privilege user, or non-privileged user.

16. The method of claim 15, further comprising:
classifying the user based on key fob proximity.

17. The method of claim 15, further comprising:
classifying the user based on facial recognition based on photos or videos captured from the camera.

18. The method of claim 17, further comprising:
classifying the inherited privilege user based on a threshold proximity from the privileged user.

19. The method of claim 15, wherein the gesture-based controls of the vehicle comprise:
moving the vehicle;
unlocking the vehicle;
capturing an image with the camera;
activating lights of the vehicle; and
starting the vehicle.

20. The method of claim 15, wherein the privileged user has access to more gesture-based controls of the vehicle compared to that of the inherited privilege user and the inherited privilege user has access to more gesture-based controls of the vehicle compared to that of the non-privileged user.
